(19) United States
(12) Patent Application Publication
(10) Pub. No.: US 2018/0150601 A1
(43) Pub. Date: May 31, 2018

(54) REDUCING CONTAGIOUS DISEASE SPREAD UTILIZING TRAVEL INFORMATION

(71) Applicant: International Business Machines Corporation, Armonk, NY (US)

(72) Inventors: Tara Astigarraga, Fairport, NY (US); Christopher V. DeRobertis, Hopewell Junction, NY (US); Louie A. Dickens, Tucson, AZ (US); Jose Roberto Mosqueda Mejia, Puruandiro (MX); Daniel J. Winarski, Tucson, AZ (US)

(21) Appl. No.: 15/796,246

(22) Filed: Oct. 27, 2017

Related U.S. Application Data
(63) Continuation of application No. 15/364,693, filed on Nov. 30, 2016.

(51) Int. Cl. G06F 19/00; G06Q 50/00; G06Q 50/14

(52) U.S. Cl. CPC G06F 19/324; G06Q 50/01; G06F 19/3431; G06Q 50/14

(57) ABSTRACT

In an approach, one or more computer processors receive a notification of one or more incidences of a contagious disease in at least one geographic region. The approach includes one or more computer processors retrieving a plurality of information associated with the contagious disease and a plurality of information associated to one or more travelers to at least one geographic region in a timeframe associated with the one or more incidences of the contagious disease. Furthermore, the approach includes one or more computer processors determining at least one action associated with the one or more incidences of the contagious disease.

### BACKGROUND OF THE INVENTION

The present invention relates generally to the field of health care, and more particularly to the use of a server-based program to receive, retrieve, and analyze data to identify and notify travelers who have recently visited locations experiencing at least one incidence of a contagious disease.

News headlines often highlight an outbreak of a serious contagious disease or virus. Many of these contagious diseases or viruses are easily transmitted and may spread from one country to another or from one geographic region to another region. Commonly, each of the countries affected by a contagious disease outbreak track, evaluate risks, and determine strategies for containing the spread of the disease. Furthermore, organizations like the World Health Organization (WHO) usually provide support and direction to affected regions to prevent the spread of a contagious disease.

### SUMMARY

Embodiments of the present invention disclose a method for one or more computer processors to receive a notification of one or more incidences of a contagious disease in at least one geographic region. The method includes monitoring, by one or more computer processors, at least one of a newsfeed, website, a blog, and a social media site to identify recent occurrences of a contagious disease. The method includes receiving, by the one or more computer processors, a notification of one or more incidences of the contagious disease in at least one geographic region. The method includes retrieving, by the one or more computer processors, travel information extracted from a passport associated with the at least one geographic region and a timeframe associated with the disease. The method includes retrieving, by the one or more computer processors, travel information input by a customs agent or other representative of a government agency associated with the at least one geographic region and a timeframe associated with the contagious disease. The method includes retrieving, by the one or more computer processors, travel information from a travel service associated with travel to the at least one geographic region and a timeframe associated with the contagious disease. The method includes retrieving, by the one or more computer processors, a plurality of information associated with the contagious disease and a plurality of information associated to one or more travelers to the at least one geographic region in a timeframe associated with the one or more incidences of the contagious disease, wherein the one or more travelers to the at least one geographic region includes travelers currently visiting the at least one geographic region and travelers who have previously visited the at least one geographic region in the timeframe associated with the contagious disease. The method includes determining, by the one or more computer processors, a level of severity associated with the one or more incidences of the contagious disease. The method includes determining, by the one or more computer processors, at least one action associated with the one or more incidences of the contagious disease based, at least in part, on the level of severity associated with the one or more incidences of the contagious disease. The method includes executing, by the one or more computer processors, the at least one action associated with the one or more incidences of the contagious disease, wherein the at least one action associated with the one or more incidences of the contagious disease includes one or more of: notifying the one or more travelers to the at least one geographic region of a potential exposure to the contagious disease, notifying a healthcare provider of a potential exposure of at least one individual in a vicinity of the healthcare provider, notifying a medical provider to set-up an appointment for the one or more travelers, notifying a governmental agency of a potential exposure to the contagious disease, and notifying one or more hospitals and healthcare providers of a need to set up an isolated area for the one or more travelers. The method includes receiving, by the one or more computer processors, a request for a medical appointment. The method includes retrieving, by the one or more computer processors, a plurality of travel information associated with the requestor. The method includes retrieving, by the one or more computer processors, information on one or more reported incidences of the contagious disease in a region traveled to by the requestor. The method includes analyzing, by the one or more computer processors, the plurality of travel information and the information of the one or more reported incidences of the contagious disease in the at least one geographic region traveled to by the requestor to determine a level of risk associated with a travel history of the requestor. The method includes prioritizing, by the one or more computer processors, a time and a location for the medical appointment based, at least in part, on the level of risk associated with the travel history of the requestor.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a correlation program, on a server within the distributed data processing environment of FIG. 1, to identify one or more actions to take in response to one or more incidences of a contagious disease, in accordance with an embodiment of the present invention;

FIG. 3 depicts a block diagram of components of a prioritization program in a server within distributed data processing environment of FIG. 1, to prioritize scheduling of a request for a medical appointment based, at least in part, on the requestor's prior travel, in accordance with an alternate embodiment of the present invention;

FIG. 4 is a flowchart depicting operational steps of the prioritization program, on a server within the distributed data processing environment of FIG. 1, to prioritize a medical appointment request based, in part, on a potential travel related exposure to a contagious disease, in accordance with an alternate embodiment of the present invention; and

FIG. 5 depicts a block diagram of components of the server computer executing the correlation program and the prioritization program within the distributed data processing environment of FIG. 1, in accordance with an embodiment of the present invention.

### DETAILED DESCRIPTION

Embodiments of the present invention recognize that most contagious diseases and viruses have an incubation period or a time required for an individual to exhibit signs or symptoms of a contagious disease or virus. Embodiments of the present invention recognize that travelers for business and pleasure often move from location to location, unaware of incidences of contagious diseases occurring in a current location or a geographic region after a visit to the location or to the region.

Embodiments of the present invention provide a method to analyze and correlate received data on one or more incidences of a contagious disease or a virus with travel information to identify at risk individuals and determine an appropriate action or actions to prevent spread of the contagious disease or virus. Embodiments of the present invention provide a method to receive notification of the incidences of the contagious disease or viruses in a geographical region. Embodiments of the present invention include a method to retrieve travel information for identification of travelers currently visiting the affected region or travelers who have previously visited the affected region or location in the timeframe associated with the contagious disease or virus. Embodiments of the present invention provide a method to determine at least one action appropriate to the one or more incidences of the contagious disease. Embodiments of the present invention provide a method to communicate the determined at least one action to potentially exposed individuals and/or appropriate healthcare providers or agencies.

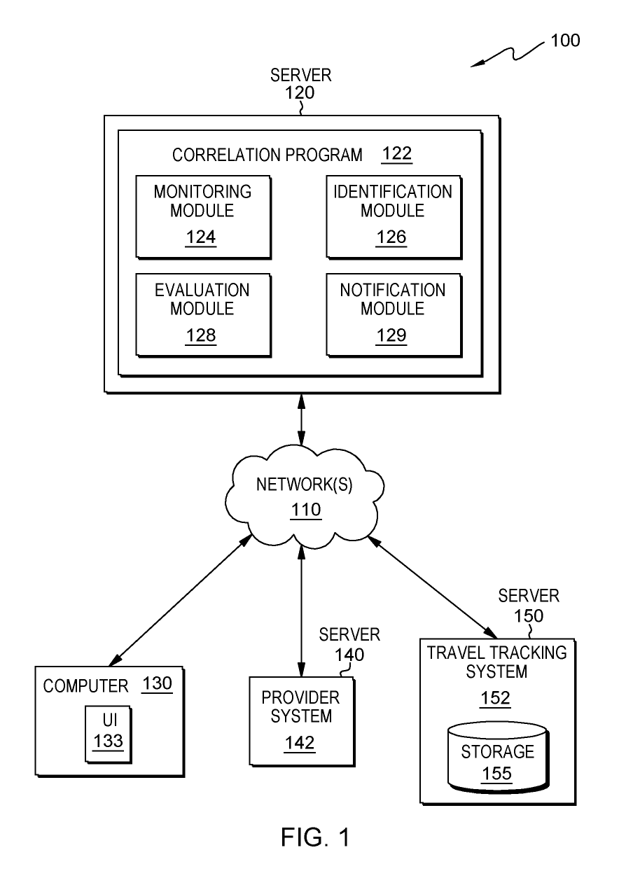

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Implementation of embodiments of the invention may take a variety of forms, and exemplary implementation details are discussed subsequently with reference to the Figures. Many modifications to the depicted environment may be made by those skilled in the art without departing from the scope of the invention as recited by the claims.

As depicted, distributed data processing environment 100 in FIG. 1 includes server 120 hosting correlation program 122, computer 130, server 140 hosting provider system 142, and server 150 hosting travel tracking system 152, interconnected over network(s) 110. Network 110 can be, for example, a telecommunications network, a local area network (LAN), a wide area network (WAN), such as the Internet, or a combination of the three, and can include wired, wireless, or fiber optic connections. Network 110 can include one or more wired and/or wireless networks that are capable of receiving and transmitting data, voice, and/or video signals, including multimedia signals that include voice, data, and video information. In general, network 110 can be any combination of connections and protocols that will support communications between computer 130 and servers 120, 140, 150, and other computing devices (not shown) within distributed data processing environment 100.

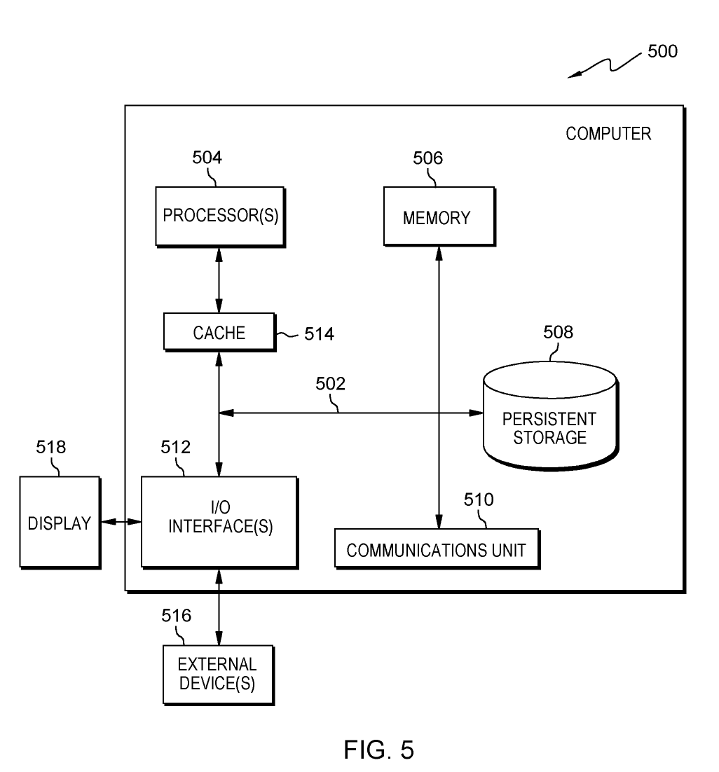

Servers 120, 140, and 150 can be standalone computing devices, management servers, web servers, mobile computing devices, or any other electronic device or computing system capable of receiving, sending, and processing data. In various embodiments, servers 120, 140, and 150 can represent a server computing systems utilizing multiple computers as a server system, such as used in a cloud computing system or in a cloud computing environment. In another embodiment, each of servers 120, 140, and 150 can be a laptop computer, a tablet computer, a netbook computer, a personal computer (PC), a desktop computer, a personal digital assistant (PDA), a smart phone, or any programmable electronic device capable of communicating with computer 130, and other computing devices (not shown) within distributed data processing environment 100 via network 110. In another embodiment, server 120, 140, and 150 represent a computing system utilizing clustered computers and components (e.g., database server computers, application server computers, etc.) that act as a single pool of seamless resources when accessed within distributed data processing environment 100. Servers 120, 140, and 150 may include internal and external hardware components, as depicted and described in further detail with respect to FIG. 5.

Server 120 includes correlation program 122. Server 120 sends and receives data to and from computer 130, servers 140 and 150. In various embodiments, server 120 utilizing correlation program 122 sends data such as a notification of a medical appointment or a notification of a potential exposure to a contagious disease to individuals visiting or who previously visited a location, country or region in a timeframe associated with an outbreak of a contagious disease or virus. Server 120 using correlation program 122 requests and receives data such as an identification of individuals travelling in a location, a country, or a geographic region affected by an outbreak of a contagious disease from a database such as storage 155 in travel tracking system 152. Server 120 using correlation program 122 sends data such as a notification of a potential exposure to a contagious disease or a notification of a medical appointment to a user of computer 130.

As depicted, correlation program 122 is resident in server 120. In an embodiment, correlation program 122 includes monitoring module 124, identification module 126, evaluation module 128, and notification module 129. In other embodiments, additional or fewer modules are present in correlation program 122. In yet another embodiment, correlation program 122 is capable of performing each of the operations performed by each of monitoring module 124, identification module 126, evaluation module 128, and notification module 129. Correlation program 122 provides the ability to retrieve information, receive a notification from travel tracking system 152, or receive a notification from a disease tracking system (e.g., from a computer system for the center for disease control (CDC)) on recently identified cases or incidences of a contagious disease or virus in a location or a geographic region. Responsive to receiving a notification of an incidence or incidences of a contagious disease, correlation program 122 retrieves information on individuals currently visiting or individuals who have visited the affected region in the timeframe associated with the incidences of the identified contagious disease.

Correlation program 122 may retrieve from persistent storage in server 120 or retrieve from a database such as a Center for Disease Control (CDC) database information related to a contagious disease. Retrieved information on the contagious disease may include ease of transmission, incubation periods, and disease severity (predicted/expected outcomes).

Based, at least in part, on the received notification of one or more incidences of a contagious disease, correlation program 122 determines a timeframe associated with the contagious disease using the time of the incidences and the retrieved incubation period of the disease. A timeframe associated with an outbreak includes the time or dates of the incidences of the contagious disease, the time of potential exposure prior to the date of the first incidence of the disease, and the time or dates of continued incidences including associated incubation periods of the contagious disease or virus.

Correlation program 122 uses the retrieved information relating to the incidences of the contagious disease to evaluate one or more actions to take in response to receiving the notification of an outbreak of the contagious disease. Additionally, correlation program 122 retrieves from a database in storage 155 in travel tracking system 152 and/or from a national disease record database (e.g., the CDC) or internal disease record database, identifications of individuals visiting an affected region or locations in the timeframe associated with an outbreak of a contagious disease. Using the received and retrieved information (e.g., incidences of the disease, location of incidences, individuals who visited the location, etc.), correlation program 122 determines one or more appropriate actions. In various embodiments, correlation program 122 notifies the respective individuals and/or health care systems or agencies of the potential risk with associated with the outbreak of the contagious disease.

Correlation program 122 may be one or more of a program in a medical group computer system, in a hospital computer system, in a local, state, national medical or health system such as the CDC, or a program in a cross-country or worldwide health care organization computer system such as a computer system supporting the World Health Organization.

In various embodiments, monitoring module 124 in correlation program 122 provides the ability to receive notifications of recent or real-time incidences of contagious diseases or viruses from various computer systems such as a system for the CDC, the event monitoring system or global outbreak alert and response network (GOARN) in the World Health Organization. Additionally, monitoring module 124 provides the ability for correlation program 122 to monitor websites, blogs, and newsfeeds on the Internet for recently identified outbreaks or occurrences of a contagious disease and extract information such as a location, dates, and the like associated with the outbreak. Monitoring module 124 sends received and/or extracted information to identification module 126 and evaluation module 128.

In various embodiments, identification module 126, responsive to receiving information such as a location or geographic region and a timeframe associated with the outbreak, when authorized, retrieves data relating to individuals who have traveled to the location or geographic region within the timeframe associated with the outbreak. Identification module 126 may retrieve data relating to individuals from one or more sources such as a database in storage 155 in travel tracking system 152 on server 150. In an embodiment, identification module 126 retrieves data such as names and contact information for individuals who have visited a geographic region where a recorded incidence of a contagious disease occurred. For example, identification module 126 retrieves from a database in storage 155 in travel tracking system 152, which is a computer system for the United States customs agency tracking individual travel outside of the country including the individuals entering the country, previous travel destinations prior to entry, length of stay, and travel plans of individuals exiting the country. Identification module 126 sends the data relating to individuals who have traveled to a geographic region affected by an outbreak of a contagious disease to evaluation module 128 and notification module 129.

In various embodiments, evaluation module 128, responsive to receiving data on incidences of a contagious disease, provides an evaluation of one or more actions to take in response to the identified outbreak based, in part, on retrieved information such as the seriousness or the level of severity of the contagious disease (e.g., predicted disease outcome) and the ease of transmission of the disease. In an embodiment, evaluation module 128 includes the received number of potentially exposed individuals to evaluate one or more actions. Evaluation module 128 retrieves information relating to the contagious disease from a number of sources such as a database in persistent storage of server 120 or retrieved from external sources such as a database of contagious disease attributes maintained by a national disease control organization (e.g., the CDC). Based on the received and retrieved information, evaluation module 128 determines one or more appropriate actions to prevent or reduce the spread of the contagious disease. Examples of retrieved and received information utilized by evaluation module 128 includes but is not limited to the number of incidences of the disease, the number of individuals potentially exposed, and the nature of the contagious disease (e.g., ease of transmission, length of incubation period, and predicted disease outcome). Evaluation module 128 provides the determined actions to notification module 129.

In various embodiments, notification module 129, responsive to receiving one or more determined actions appropriate to the incidences of the contagious disease from evaluation module 128, sends notifications of the potential risk of the contagious disease occurrences. The notifications may be sent to one or more of a computer system of a state, local, or federal agency, provider system 142 for a hospital or health care provider, or to individuals who may have been exposed to the contagious disease in a current stay or a previous visit to the affected geographic region of the outbreak.

Computer 130 can be one or more of a smart phone, a wearable computing device such as a smart watch, a laptop computer, a tablet computer, or any programmable electronic device capable of communicating with various components and devices within distributed data processing environment 100, via network 110. In general, computer 130 represents any programmable electronic device or combination of programmable electronic devices capable of executing machine readable program instructions and communicating with servers 120, 140, 150, and other computing devices (not shown) within distributed data processing environment 100 via a network, such as network 110. One or more computing devices such as computers 130 (e.g., clients to server 120) may be present in distributed data processing environment 100. As depicted, computer 130 includes an instance of a user interface (UI) 133. UI 133 provides a known interface for a user of computer 130 to interact with servers 120, 140, and 150, for example to display a notification received from correlation program 122 in server 120. Computer 130 may include internal and external hardware components, as depicted and described in further detail with respect to FIG. 5

Provider system 142 may be one or more of a computer system supporting a hospital, a medical practice, a physician, or a healthcare organization (e.g., a private healthcare organization such as an insurer, a local, state, federal, or multi-national health organization). In an embodiment, provider system 142 is a system for a hospital or a medical practice that is capable of receiving notifications and providing one or more appropriate actions in response (e.g., receiving a request to set-up an appointment for a potentially exposed individual and providing a time, a location, and a confirmation of appointment completion to correlation program 122 or setting up an isolated area for quarantining potentially exposed individuals). In one embodiment, correlation program 122 queries provider system 142 for information relating to the contagious disease and/or for additional information (e.g., age, health risks, etc.) on potentially exposed individuals who are a client of a caretaker supported by provider system 142.

Server 150 includes travel tracking system 152 with storage 155. In various embodiments, travel tracking system 152 is a computer system supporting a customs agency or another government agency tracking entry and exit of individuals into a country or a region. In an embodiment, travel tracking system 152 on server 150 is a computer system supporting a travel service company or other website of a company that coordinates and stores travel plans/records associated with individuals and/or clients. In various embodiments, travel tracking system 152 and storage 155 reside on more than one server or more than one computer system.

Storage 155 resident in server 150 is a repository for travel tracking data provided by travel tracking system 152. Storage 155 may include one or more databases capable of receiving, organizing, retrieving, and storing data such as travel information provided by travel tracking system 152 or any additional sources (not depicted in FIG. 1). For example, storage 155 may receive from a travel company (e.g., travel tracking system 152) hotel confirmations used to determine a location of a traveler visiting a region or country. In another example, storage 155 may receive notifications such as a notification of a traffic violation or other legal infraction from a law enforcement agency that may relate to the tracking the location or travel of an individual.

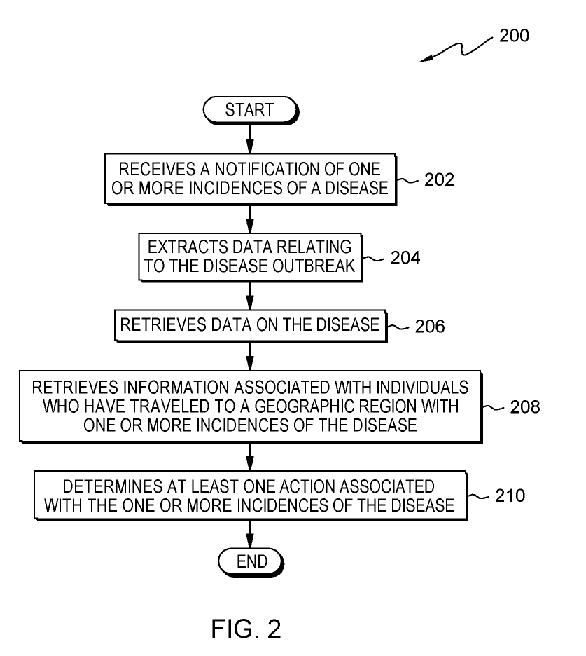

FIG. 2 is a flowchart 200 depicting operational steps of correlation program 122, on server 120 within the distributed data processing environment 100 of FIG. 1, to identify one or more actions to take in response to one or more incidences of a contagious disease, in accordance with an embodiment of the present invention.

Correlation program 122 receives a notification of one or more incidences of a disease (202). In various embodiments, correlation program 122 receives a notification of one or more incidences of a contagious disease or a virus occurring in an identified location or an identified geographic region. Correlation program 122 may receive a notification or an alert of a recently occurring outbreak of a contagious disease from one or more of a healthcare provider, a volunteer agency, a hospital, a medical group, a national healthcare organization (e.g., CDC), a multi-country health organization (e.g., the World Health Organization). The notification received includes a location or one or more geographic regions in which the incidences or outbreak is observed.

The notification may include information such as the type of contagious disease or virus, the first date occurring at each location, the location or locations of incidences, the number of incidences, links to medical information associated with the contagious disease, the rapidity of the disease progression in the reported incidences, and other similar information related to the outbreak.

In an embodiment, correlation program 122 monitors various blogs, newsfeeds, websites, social media sites, or other similar information sources to identify outbreaks of a contagious disease or virus. Correlation program 122 may monitor websites, blogs, and news feeds on the Internet using methods known to one skilled in the art such as utilizing Rich Site Summary or Really Simple Syndication (RSS), Resource Description Framework (RDF), Atom Syndication Format, RESTful interfaces, and the like for recently identified outbreaks of a contagious disease. In one embodiment, correlation program 122 periodically sends a query to one or more databases to identify incidences of recently reported cases of contagious diseases or viruses. For example, correlation program 122 monitors the CDC website or the CDC database of recorded incidences of contagious diseases.

Correlation program 122 extracts data relating to the disease outbreak (204) from the notification. Information extracted from the notification on the incidence(s) of a contagious disease or virus includes but, is not limited to one or more of the type/name of the contagious disease occurring, the locations or affected regions where the contagious disease occurs, the number individuals affected, the rapidity or rate of progression of the disease in the various reported incidences (if known), dates associated with the outbreak, and other similar provided information relating to the outbreak.

In various embodiments, correlation program 122 monitoring any of a blog such as volunteer agency blog, a healthcare network agency website, a newsfeed, or other database as a source of information on emerging diseases or viral outbreaks extracts information relating to an identified incidence or incidences of a contagious disease. For example, correlation program 122 may extract from a website or a blog associated with multi-national group of medical professionals such as Doctors Without Borders/Médecins Sans Frontières (MSF) USA® information such as a date, a number of affected individuals, and a location of incidences of a contagious disease that may indicate an outbreak of the disease or a virus. In an embodiment, correlation program 122 sends a query or a request for newly reported incidences or recently posted comments on reported cases of a contagious illness to a database, newsfeed, blogs, or website on a regularly scheduled frequency (e.g., every day).

Correlation program 122 retrieves data on the disease (206) from one or more databases. Correlation program 122 retrieves from a database (e.g., a database on contagious diseases in the CDC computer system or in the World Health Organization computer system) information the contagious disease. For example, the retrieved information on the disease includes but is not limited to ease of disease transmission, disease transmission mode, incubation period of the contagious disease, symptoms of the disease, historical outcomes (e.g., predicted disease outcome), prevention methods, effectiveness of prevention methods, and other similar information related to the contagious disease.

In various embodiments, correlation program 122 determines an evaluation of the level of severity of the outbreak of the contagious disease or virus. The level of severity or risk associated with the outbreak may be determined based, at least in part, on the retrieved data on the contagious disease, the information extracted related from the notification or the information extracted from a blog or website being monitored. The extracted information includes data such as the number of individuals reported with the contagious disease, the number of locations or geographic regions affected by the contagious disease, the reported progression of the disease in the one or more reported incidences, and other similar data or information. In various embodiments, correlation program 122 determines a level of severity of an outbreak as low, medium, high, or very high. Correlation program 122 can be configured to determine the level of severity of the outbreak based on one or more of the number of incidences of the contagious disease, the ease of disease transmission (e.g., how quickly it could spread), the mode of disease transmission (e.g., airborne or by insects), the historical disease outcome, the number of locations and/or the size of the region or regions affected by the outbreak. In this example, one or more reported incidences of an airborne disease easily transmitted with very serious predicted outcome (e.g., a high mortality rate) would be evaluated as an outbreak of a contagious disease with a very high level of severity (e.g., a contagious disease associated with a very high level of risk).

Correlation program 122 retrieves information associated with identified individuals who have traveled to a geographic region with one or more incidences of the disease (208). Using information extracted from a received notification or retrieved from a database (e.g., CDC database) on dates and locations or geographic regions where an outbreak or cases of the contagious disease occurred, correlation program 122 retrieves information associated with individuals who are or have been visitors of the geographic region or locations where the outbreak occurred during the timeframe when the outbreak occurred. In an embodiment, correlation program 122 automatically correlates received information on an outbreak of one or more incidences of a contagious disease or virus with information provided by a traveler or extracted from a traveler's passport on one or more locations or geographic regions visited that is input into a customs database or other port of entry of a computer system. For example, correlation program 122 automatically sends a notification of a potential disease exposure to computer 130 for display on UI 133 to the traveler and to the computer system of the custom agent or other representative inputting the information for display to the agent or representative.

In various embodiments, correlation program 122 retrieves information from a database (e.g., a customs database) in storage 155. The retrieved information includes one or more of dates of a visit to an affected geographic region, a traveler's name, contact information, address, future destinations, and other information related to identifying and contacting individuals who have visited a geographic region or location during the timeframe of an outbreak, and the like. Using extracted data on the locations or geographic region of the incidences of the contagious disease and the dates when the outbreak occurred, correlation program 122 queries one or more databases to identify individuals who have traveled in the vicinity of the locations where the outbreak was observed. Correlation program 122 queries one or more of a database in storage 155 (e.g., a customs or port of entry database), one or more travel service databases, one or more of an airline, train, rental car, or other travel related or transportation related database that may include previous destinations.

In one embodiment, correlation program 122 retrieves from a customs database in storage 155 information scanned or entered into travel tracking system 152 associated with various ports of exit or entry into a country. Using methods known to one skilled in the art, travel information associated with the passports of travelers entering or exiting a country may be scanned or read into travel tracking system 152 for entry into storage 155. The passport may be scanned or electronically read for barcodes, QR codes, stamps, or other marks identifying countries previously visited and dates of a visit. In an embodiment, correlation program 122 retrieves travel information such as previous locations or country visited, dates of visit/length of stay, reasons for visit, and future/planned destinations verbally collected by customs agents or other representatives. The customs agent enters the verbally collected into travel tracking system 152 to save in a database in storage 155 accessible for information retrieval by correlation program 122.

In various embodiments, correlation program 122 sends a query to the one or more databases (e.g., a database in storage 155 within travel tracking system 152) to identify individuals who have recently traveled to the location, locations or region affected by the outbreak. The query may include a timeframe, determined based in part on an incubation period of the disease and the initial time of the outbreak. In some embodiments, correlation program 122 monitors or queries various national or organizational databases, websites, and news feeds to identify and retrieve data on new outbreaks or the emergence of various contagious diseases or viruses. For example, correlation program 122 periodically or on a regular schedule sends a query to a database to receive information on recently occurring outbreaks of a contagious disease. For example, correlation program 122 may query one or more databases in an event management system of the World Health Organization, a database maintained by a country (e.g., a country at high risk of certain contagious diseases), or a database of the CDC to identify recent incidences of contagious diseases, viruses, or other specific identified diseases.

In an embodiment, correlation program 122 retrieves from a database of passport information the names and contact information for travelers who requested to receive a notification of any health related information such as occurrences of contagious diseases when applying for a passport. For example, as a part of the passport application, a line, a box, or a question asks if the passport owner would like to be notified (e.g., by a preferred method such as e-mail, by social media, by text, by letter, or by telephone) of any contagious diseases occurring in currently or previously visited geographic regions or location. In one embodiment, correlation program 122 searches social media, to identify users or userids of people discussing travel relating to one or more regions around the dates of the outbreak.

In an embodiment, correlation program 122 requests or retrieves from a travel booking service database, when legally permissible, an identification of one or more travelers visiting a geographic region or a destination during or prior to an outbreak. For example, correlation program 122 requests information on clients travelling to a geographic region during dates associated with an outbreak of a contagious disease from a travel service system supporting a number of corporations. Correlation program 122 requests from travel company XYZ's computer system data on clients travelling or who have travelled to a geographic region with an outbreak of a contagious disease. In one embodiment, correlation program 122 is associated with a travel service or is a part of travel company XYZ's computer system and automatically retrieves or receives information on emerging or recent incidences of a contagious disease that is automatically correlated with clients travelling or who have travelled to an affected region in a timeframe associated with the outbreak. In this example, correlation program 122 using the resources of travel company XYZ's system contacts the clients at risk of exposure to the contagious disease (e.g., correlation program 122 provides an additional service to clients of travel company XYZ that integrates correlation program 122 into the travel company computer system).

Correlation program 122 determines at least one action associated with the one or more incidences of the disease (210). In various embodiments, correlation program 122 determines at least one action to take based on a determined level of severity of the outbreak. For example, correlation program 122 initiates an automatic contact action. The automatic contact action may include one or more of automatic or automated calls, e-mails, social media messages, and texts to the travelers who visited a region or a location of the one more incidences in the timeframe associated with the outbreak.

In an embodiment, correlation program 122 confirms that a communication or notification is received by an individual viewing UI 133 on computer 130 (e.g., by requesting a delivery notification). In one embodiment, correlation program 122 determines the number of communications to send and/or the need for delivery confirmation based, at least in part, on the determined level of severity of the outbreak (e.g., a low level of severity of an outbreak may be configured to send only an electronic communication and no delivery receipt). In one embodiment, correlation program 122 automatically contacts a hospital, a doctor, or a medical center associated with the traveler or in the vicinity of the traveler. For example, when correlation program 122 identifies a traveler as a visitor of an affected region during the timeframe of an outbreak then correlation program 122 automatically initiates an appointment with a medical professional. For example, correlation program 122 electronically initiates a request to set-up an appointment of an at risk traveler using e-mail. Correlation program 122 may send an e-mail to a hospital near or in the vicinity of the traveler's home, for example, in situations where the risk to the traveler or the level of severity of the outbreak is very high. In one embodiment, correlation program 122 verifies, for example by an e-mail to the medical professional or hospital, that the traveler has completed his or her appointment and if not, correlation program 122 automatically contacts the traveler again with another appointment. In one embodiment, correlation program 122 contacts the appropriate state, local or national public healthcare organization with the travelers name/contact information for outbreaks of a very high level of severity or risk the general public, in accordance with prevailing legal privacy restrictions.

In various embodiments, the actions taken by correlation program 122 include automatically contacting travelers to an affected region to provide them with information regarding the outbreak. For example, correlation program 122 may automatically send a communication (e.g., an email, text, or call) to the potentially exposed travelers informing the travelers of the incidence of contagious disease during or after their travels. The communication may include a list of symptoms associated with the contagious disease, an incubation period for the contagious disease, suggested actions (e.g., set-up an appointment with your healthcare provider in the next month or monitor your temperature for the next week), and providing the names or links to websites with additional medical information on the contagious disease.

In various embodiments, correlation program 122 is configured to provide action plans associated with the determined level of severity of the outbreak to which a traveler is exposed. For example, correlation program 122 is configured to provide each determined level of severity associated with a contagious disease or an outbreak of a contagious disease with one or more actions associated with the level of severity. Upon determining one or more actions associated with a potentially exposed traveler, correlation program 122 executes the one or more actions. For example, correlation program 122 sends a notification of a potential exposure to a contagious disease to travelers visiting or who have visited a geographic region with an outbreak of the contagious disease or virus.

In one embodiment, correlation program 122 automatically sends an alert or an electronic notification to healthcare providers (e.g., walk-in clinics, medical practices, hospitals, and the like) in the vicinity of one or more travelers to a region or location in the timeframe of an outbreak. For example, when correlation program 122 determines a low to medium level of severity or risk associated with the outbreak (e.g., a flu virus), then correlation program 122 sends an alert or a notification to hospitals and walk-in clinics within a fifty mile radius of a potentially infected traveler's home address.

In an embodiment, the action taken by correlation program 122 includes sending to hospitals in the vicinity of travelers potentially exposed to a contagious disease with a very high level of severity a notification (e.g., an e-mail and/or other automatic contact method) alerting the hospital to set-up an isolated area or a quarantine area for potential exposed travelers and/or individuals exhibiting symptoms associated with the disease. The communication may include directions to initiate required quarantine procedures in outbreaks determined with an extremely high level of severity.

The operational steps of correlation program 122 discussed with respect to FIG. 2 are provided in an order as outlined above, however, as one skilled in the art will recognize, in an embodiment of the present invention, step 206 is performed before steps 202 and 204. Performing step 206 before steps 202 and 204 does not influence or change the outcome of correlation program 122 in a significant manner (i.e., a similar action or actions are determined).

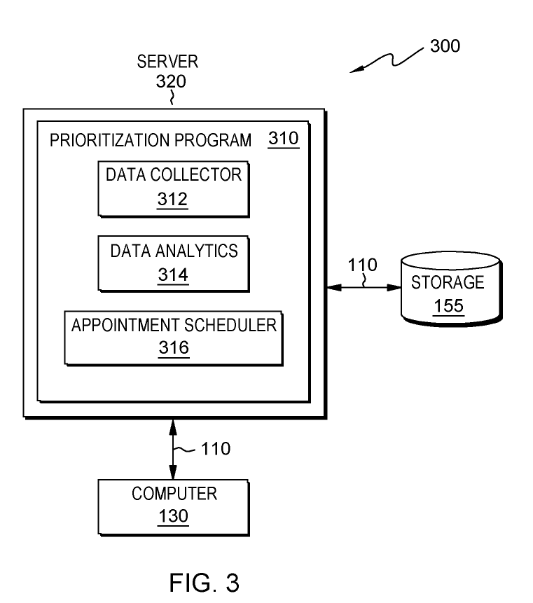

FIG. 3 depicts a block diagram 300 of components of prioritization program 310 in server 320 within distributed data processing environment 100 of FIG. 1, to prioritize scheduling of a request for a medical appointment based, at least in part, on the requestor's prior travel, in accordance with an alternate embodiment of the present invention. The alternative embodiment using prioritization program 310 discussed with reference to FIG. 3 may be included in distributed data processing environment 100 along with correlation program 122 on server 120, may be a separate embodiment without correlation program 122 on server 120, or may not be present in distributed data processing environment 100. As depicted, FIG. 3 includes server 320 with prioritization program 310 (not depicted in FIG. 1), computer 130, and storage 155 interconnected via network 110 as depicted in FIG. 1. Server 320 is another server within distributed data processing environment 100, which is not depicted in FIG. 1.

Server 320 can provide similar function and capabilities as servers 120, 140, and 150 as discussed in detail with reference to FIG. 1. Server 320 may include internal and external hardware components, as depicted and described in further detail with respect to FIG. 5.

In an alternative embodiment of the present invention, prioritization program 310 is a program resident on server 320 that receives a request for a medical appointment from a user of computer 130. Responsive to receiving a request for a medical appointment, prioritization program 310 retrieves from a contagious disease database such as a database in the medical provider's computer system or a database in a health organization (e.g., the CDC's) computer system storing information on known contagious disease or virus outbreaks in a pre-set timeframe. The timeframe, configured in prioritization program 310, may be the last year, the last 3 months, or since the requestor's last appointment. Prioritization program 310 retrieves from a database storing known data on the contagious disease, for example, from a CDC database collecting information on the observed contagious disease or diseases such as symptoms, incubation period, method of spread, ease of transmission, and the like. Prioritization program 310, when authorized, retrieves data on the requestor's travel associated with a timeframe configured in prioritization program 310. Prioritization program 310 analyzes the retrieved information to determine a priority for the requested appointment, a location for the appointment, and any additional actions (e.g., notifying the requestor of any potential exposure and recommended actions). Prioritization program 310 communicates a scheduled appointment time and location along with any other determined actions to the requestor and any additional determined entities or agencies.

In an embodiment, prioritization program 310 in server 320 includes data collector 312, data analytics 314, and appointment scheduler 316 as components of prioritization program 310 used to execute the above evaluation and actions.

Data collector 312 in prioritization program 310 includes the codes and routines to retrieve, receive, and extract travel information associated with historical or previous travel of the requestor with in a configured timeframe (e.g., from the requestor's last appointment). Data collector 312 may execute one or more of the following actions to receive travel information associated with the requestor. For example, data collector 312, in prioritization program 310, sends a query to a database in storage 155 to retrieve information on previous travel by the requestor. Storage 155 stores information relating to an individual's travel and/or entry and exit into a country or a region (e.g., stores customs data). The information stored in storage 155, previously discussed in reference to FIGS. 1 and 2, may include countries visited by the requestor, dates/length of stay by the requestor, etc. from customs or from a travel service system. In one embodiment, data collector 312 receives from a requestor input providing previous travel activities via an electronic form used to request a medical appointment (e.g., travel outside of the country and to different states/providences within a home country in the identified timeframe).

Data analytics 314 analyzes the received travel information to determine any potential risk of exposure to contagious diseases to the requestor based on the previously visited regions. If the requestor has limited to no travel outside of the country and/or within the requestors home country in the configured timeframe, no additional action may be needed. In an embodiment, data analytics 314 is configured with a list of countries with a high risk of contagious diseases. If data analytics 314 determines that the requestor has recently traveled to a country with a high risk of contagious disease, then data analytics 314 retrieves from a database (e.g., in CDC or in a computer system of the World Health Organization) a list of countries experiencing an outbreak during the configured timeframe. Based, at least in part, on a correlation of the requestors travel information on countries or geographic regions visited and the retrieved list of countries and/or regions affected by a contagious disease data analytics 314 determines a potential risk that the requestor may be infected or has been exposed to an outbreak of a contagious disease. Data analytics 314 provides the potential risk to appointment scheduler 316.

Appointment scheduler 316 assigns the priority for the appointment and the location of the medical appointment based, at least in part, on the potential risk that the requestor may be infected or have been exposed to a contagious disease. For example, if the determined risk by data analytics 314 is low, then appointment scheduler 316 assigns the appointment a normal priority. Appointment scheduler 316 schedules a first available time at the normal or standard appointment location. In another example, if data analytics 314 provides an assessment of a high potential risk that the requestor may have been exposed to or be infected with a contagious disease, appointment scheduler 316 assigns a high priority for scheduling the appointment. In an embodiment, appointment scheduler 316 schedules a requestor at a high risk of a contagious disease at a remote or isolated section of the medical facility.

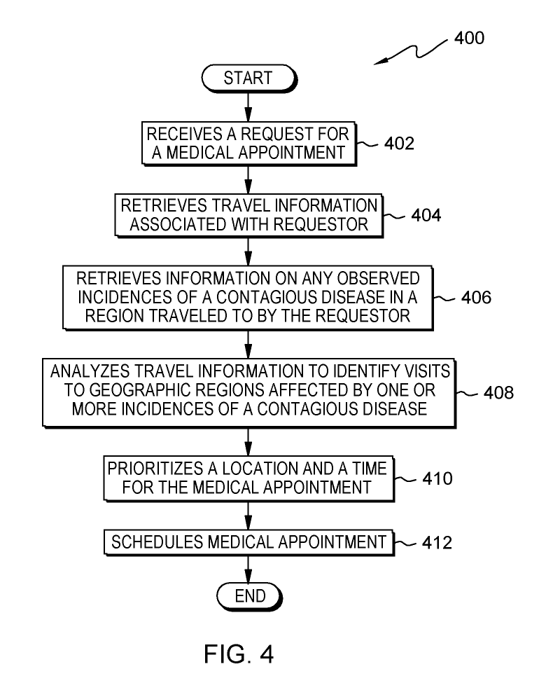

FIG. 4 is a flowchart 400 depicting operational steps of prioritization program 310, on server 320 within the distributed data processing environment 100 of FIG. 1, to prioritize a medical appointment request based, on part, on a potential travel related exposure to a contagious disease, in accordance with an alternate embodiment of the present invention.

Prioritization program 310 receives a request for a medical appointment (402). Prioritization program 310, for example using known methods, receives from a requestor, a receptionist, or an automated call system, a notification or an e-mail request for a medical appointment with an associated medical provider. Responsive to receiving the request, prioritization program 310 takes various steps. In various embodiments, prioritization program 310 retrieves travel information associated with the requestor (404). Prioritization program 310 retrieves the requestor's travel data related to the timeframe configured in prioritization program 310 (e.g., requestor travel data associated with the last six months). The timeframe configured in prioritization program 310 may be the last three months, the last year, or since the requestor's last appointment. In an embodiment, a requestor, as a part of becoming a medical provider's patient or as a part of the appointment request process, has indicated or selected an option allowing prioritization program 310 to retrieve previous travel to other countries or regions from a database in storage 155 (e.g., a customs agency travel data storage). In one embodiment, a governing body such as a state or national government health agency, in certain instance, for example during a significant contagious disease outbreak, approves a search of a patient's travel history (e.g., when the patient is exhibiting symptoms of one or more incidences of a contagious disease). Prioritization program 310 requests and receives travel information from one or more of the sources as previously discussed in step 208 of FIG. 2.

Prioritization program 310 retrieves information on any observed incidences of a contagious disease in a region traveled to by the requestor (406). For example, using the methods discussed previously with reference to step 202 in FIG. 2, prioritization program 310 retrieves from a database in storage 155 or by any of the previously discussed methods to extract or determine one or more incidences of a contagious disease (e.g., discussed with reference to step 202 in FIG. 2). For example, prioritization program 310 retrieves information on observed incidences of a contagious disease from storage 155 which is a computer storage for a customs agency or other governmental agency saving travel information on individuals who entered and/or exited one or more countries or regions. In various embodiments, prioritization program 310 accesses a database in persistent storage of the medical provider's computer system or queries a database associated with a disease control organization such as the CDC to retrieve information on a contagious disease (i.e., a disease with the occurring incidences or outbreak). In various embodiments, the information retrieved by prioritization program 310 includes detailed information on the contagious diseases occurring in each country or geographic region visited by the requestor in the configured timeframe. The detailed information on the contagious disease or virus may include information such as disease symptoms, incubation period, method of transfer, and the like. The detailed information on the observed contagious disease or diseases present in a region or country visited by the requestor may be retrieved from storage 155 or another storage location such as a comprehensive contagious disease database stored in a computer system for the CDC.

Prioritization program 310 analyzes travel information to identify visits to geographic regions affected by one or more incidences of a contagious disease (408). Based, at least in part on, the retrieved information on the requestor's travel history, retrieved information on outbreaks of a contagious disease in a geographic region or country visited by the requestor in the configured timeframe, and retrieved information on the contagious disease; prioritization program 310 determines a level of risk associated with the requestor's travel history. For example, the level of risk is associated with a level of severity of an outbreak as discussed previously with regard to step 204 in FIG. 2. Prioritization program 310 includes in the analysis on the requestor's travel retrieved information on the timing of an outbreak and includes a consideration of the contagious disease's incubation period.

Based, at least in part, on the retrieved information on outbreaks associated with the configured timeframe, prioritization program 310 prioritizes a location and a time for the medical appointment (410). If prioritization program 310 determines that the requestor has not been to a region with any outbreaks of a contagious disease, prioritization program schedules the appointment with normal priority (e.g., first available time) at the standard or usual medical facility associated with regularly visited health care provider.

When prioritization program 310 determines that the requestor or requesting patient has frequented or visited a geographic region or a location associated with an outbreak of a contagious disease within the configured timeframe, then prioritization program 310 provides a higher prioritization for the requestor's appointment. In an embodiment, prioritization program 310 determines the priority to use in scheduling a requested appointment based on the level of severity of the contagious disease to which the requestor may have been exposed. For example, prioritization program 310 determines an extremely high priority corresponding to a high level of severity of an outbreak of a contagious disease. A level of severity of an outbreak of a contagious disease may be determined as previously discussed with respect to step 202 of FIG. 2. In an embodiment, prioritization program 310 determines the level of severity of the contagious disease by the ease of transmission of the contagious disease and the predicted or expected disease outcome. For example, prioritization program 310 is configured to immediately prioritize or schedule an emergency appointment with a healthcare provider in an isolated section of the facility when the requestor has visited a region affected by an outbreak of an easily transmitted disease with serious predicted outcomes. Based on the prioritization and a determined location, prioritization program 310 schedules a medical appointment (412) for the requestor with the medical provider. Responsive to scheduling the appointment, prioritization program 310 sends a notification of the appointment to the requestor using known methods (e.g., by e-mail, a text message, an automatic voice message or the like). In an embodiment, prioritization program 310 notifies a governmental agency of the scheduled appointment.

FIG. 5 depicts a block diagram 500 of components of a computing system, such as servers 120, 140, 150, and 320 and computer 130 as discussed above with reference to FIGS. 1 and 3, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Servers 120, 140, 150, and 320 and computer 130 can include processor(s) 504, cache 514, memory 506, persistent storage 508, communications unit 510, input/output (I/O) interface(s) 512 and communications fabric 502. Communications fabric 502 provides communications between cache 514, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In an embodiment, memory 506 includes random access memory (RAM). In general, memory 506 can include any suitable volatile or non-volatile computer readable storage media. Cache 514 is a fast memory that enhances the performance of processor(s) 504 by holding recently accessed data, and data near recently accessed data, from memory 506.

Program instructions and data used to practice embodiments of the present invention, e.g., correlation program 122, are stored in persistent storage 508 for execution and/or access by one or more of the respective processor(s) 504 of server 120 or server 320 via cache 514. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of computer 130, server 140, server 150, and storage 155 depicted in FIG. 1. In these examples, communications unit 510 includes one or more network interface cards. Communications unit 510 may provide communications through the use of either or both physical and wireless communications links. Correlation program 122 may be downloaded to persistent storage 508 of server 120 through communications unit 510. Prioritization program 310 may be downloaded to persistent storage 508 of server 320 through communications unit 510.

I/O interface(s) 512 allows for input and output of data with other devices that may be connected to server 120 and server 320. For example, I/O interface(s) 512 may provide a connection to external device(s) 516 such as a keyboard, a keypad, a touch screen, a microphone, a digital camera, and/or some other suitable input device. External device(s) 516 can also include portable computer readable storage media such as, for example, thumb drives, portable optical or magnetic disks, and memory cards. Software and data used to practice embodiments of the present invention, e.g., correlation program 122 on server 120, and/or prioritization program 310 on server 320 can be stored on such portable computer readable storage media and can be loaded onto persistent storage 508 via I/O interface(s) 512. I/O interface(s) 512 also connect to a display 518.

Display 518 provides a mechanism to display data to a user and may be, for example, a computer monitor. Display 518 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method comprising:
monitoring, by one or more computer processors, at least one of a newsfeed, website, a blog, and a social media site to identify recent occurrences of a contagious disease;
receiving, by the one or more computer processors, a notification of one or more incidences of the contagious disease in at least one geographic region;
retrieving, by the one or more computer processors, travel information extracted from a passport associated with the at least one geographic region and a timeframe associated with the disease;
retrieving, by the one or more computer processors, travel information input by a customs agent or other representative of a government agency associated with the at least one geographic region and a timeframe associated with the contagious disease;
retrieving, by the one or more computer processors, travel information from a travel service associated with travel to the at least one geographic region and a timeframe associated with the contagious disease;
retrieving, by the one or more computer processors, a plurality of information associated with the contagious disease and a plurality of information associated to one or more travelers to the at least one geographic region in a timeframe associated with the one or more incidences of the contagious disease, wherein the one or more travelers to the at least one geographic region includes travelers currently visiting the at least one geographic region and travelers who have previously visited the at least one geographic region in the timeframe associated with the contagious disease;
determining, by the one or more computer processors, a level of severity associated with the one or more incidences of the contagious disease;
determining, by the one or more computer processors, at least one action associated with the one or more incidences of the contagious disease based, at least in part, on the level of severity associated with the one or more incidences of the contagious disease;
executing, by the one or more computer processors, the at least one action associated with the one or more incidences of the contagious disease, wherein the at least one action associated with the one or more incidences of the contagious disease includes one or more of:
notifying the one or more travelers to the at least one geographic region of a potential exposure to the contagious disease, notifying a healthcare provider of a potential exposure of at least one individual in a vicinity of the healthcare provider, notifying a medical provider to set-up an appointment for the one or more travelers, notifying a governmental agency of a potential exposure to the contagious disease, and notifying one or more hospitals and healthcare providers of a need to set up an isolated area for the one or more travelers;
receiving, by the one or more computer processors, a request for a medical appointment;
retrieving, by the one or more computer processors, a plurality of travel information associated with the requestor;
retrieving, by the one or more computer processors, information on one or more reported incidences of the contagious disease in a region traveled to by the requestor;
analyzing, by the one or more computer processors, the plurality of travel information and the information of the one or more reported incidences of the contagious disease in the at least one geographic region traveled to by the requestor to determine a level of risk associated with a travel history of the requestor; and
prioritizing, by the one or more computer processors, a time and a location for the medical appointment based, at least in part, on the level of risk associated with the travel history of the requestor.
